(19) United States
(12) Patent Application Publication
(10) Pub. No.: US 2022/0393177 A1
(43) Pub. Date: Dec. 8, 2022

(54) POSITIVE ELECTRODE FOR NONAQUEOUS ELECTROLYTE SECONDARY BATTERIES AND NONAQUEOUS ELECTROLYTE SECONDARY BATTERY

(71) Applicant: SANYO Electric Co., Ltd., Kadoma-shi, Osaka (JP)

(72) Inventors: Yukitoshi Uehara, Aichi (JP); Kazunori Donoue, Hyogo (JP); Shinya Miyazaki, Hyogo (JP)

(73) Assignee: SANYO Electric Co., Ltd., Kadoma-shi, Osaka (JP)

(21) Appl. No.: 17/785,211

(22) PCT Filed: Dec. 8, 2020
(86) PCT No.: PCT/JP2020/045579

§ 371 Date: Jun. 14, 2022

(30) Foreign Application Priority Data
Dec. 18, 2019 (JP) 2019-228042

(51) Int. Cl. H01M 4/62; H01M 10/0525

(52) U.S. Cl. CPC H01M 4/623; H01M 4/625; H01M 10/0525; H01M 2004/028

(57) ABSTRACT

This positive electrode for nonaqueous electrolyte secondary batteries is provided with a positive electrode core body and a positive electrode mixture layer that is formed on the surface of the positive electrode core body. The positive electrode mixture layer has a void fraction of from 23% by volume to 50% by volume; the positive electrode mixture layer contains at least a positive electrode active material, carbon nanotubes serving as a conductive assistant, and a polyvinylidene fluoride serving as a binder; the carbon nanotubes have a particle diameter of from 5 nm to 40 nm and an aspect ratio of from 100 to 1,000; the content of the carbon nanotubes in the positive electrode mixture layer is from 0.2% by mass to 5% by mass; and the number of polyvinylidene fluoride molecules contained per unit mass of the positive electrode mixture layer is from 0.005 to 0.030.

### TECHNICAL FIELD

The present disclosure relates to a positive electrode for non-aqueous electrolyte secondary battery and a non-aqueous electrolyte secondary battery.

### BACKGROUND

In recent years, secondary batteries are required to have increasingly higher capacities. Patent Literature 1 discloses a high-capacity secondary battery in which the density of the positive electrode active material in the positive electrode mixture layer is increased to 3.7 g/cc or higher by setting the volume ratio of the positive electrode active material in the positive electrode mixture to 97.1% to 99.6% and setting the volume ratio of voids in the positive electrode mixture layer to 16% to 72%.

Further, a high-capacity secondary battery can be obtained by configuring such that, in the positive electrode mixture layer, the positive electrode active material content is increased while the binder content is reduced. Patent Literature 2 discloses that a positive electrode mixture slurry having suitable properties for producing a high-capacity positive electrode mixture layer can be obtained by including polyvinylidene fluoride having a molecular weight of 600,000 to 1 million as a binder and controlling the preparation temperature to 30° C. to 60° C.

### CITATION LIST

### Patent Literature

PATENT LITERATURE 1: Japanese Unexamined Patent Application Publication No. 2015-43257

PATENT LITERATURE 2: JP 4263501 B

### SUMMARY

When the density of the positive electrode mixture layer is increased as disclosed in Patent Literature 1, it becomes difficult for lithium ions to move between the particles of the positive electrode active material, and this may result in high resistance. Further, even when polyvinylidene fluoride having a molecular weight of 600,000 to 1 million is used as disclosed in Patent Literature 2, if the polyvinylidene fluoride content is small, the stability of the positive electrode mixture slurry deteriorates, which may lead to high resistance. Since battery resistance is not taken into consideration in the techniques disclosed in Patent Literature 1 and 2, these techniques still have room for improvement.

A positive electrode for non-aqueous electrolyte secondary battery according to one aspect of the present disclosure includes a positive electrode core and a positive electrode mixture layer formed on a surface of the positive electrode core. The porosity of the positive electrode mixture layer is 23% by volume to 50% by volume. The positive electrode mixture layer contains at least a positive electrode active material, carbon nanotubes serving as a conductive auxiliary material, and polyvinylidene fluoride serving as a binder. The carbon nanotubes have a particle diameter of 5 nm to 40 nm and an aspect ratio of 100 to 1000, and the carbon nanotube content in the positive electrode mixture layer is 0.2% by mass to 5% by mass. The number of molecules of the polyvinylidene fluoride contained per unit mass of the positive electrode mixture layer is 0.005 to 0.030.

A non-aqueous electrolyte secondary battery according to one aspect of the present disclosure includes the above-described positive electrode for non-aqueous electrolyte secondary battery, a negative electrode, and a non-aqueous electrolyte.

According to the present disclosure, it is possible to provide a secondary battery having high capacity and low resistance.

### BRIEF DESCRIPTION OF DRAWINGS

FIG. 1 is a perspective view of a secondary battery according to an example embodiment, and shows a structure inside a battery housing with a front side of an outer casing, removed.

### DESCRIPTION OF EMBODIMENTS

There is a demand for secondary batteries with high capacity and high output. By reducing the porosity and increasing the density of the positive electrode mixture layer, the capacity of the secondary battery can be increased, but it becomes difficult for lithium ions to move between the positive electrode active material particles, and high resistance nay be caused in the secondary battery. As a result of diligent studies by the present inventors, it has been found that a secondary battery achieving both high capacity and low resistance can be obtained by adding a predetermined amount of carbon nanotubes Laving a high aspect ratio and setting the number of molecules of polyvinylidene fluoride contained per unit mass of the positive electrode mixture layer to a predetermined range, while adjusting the porosity of the positive electrode mixture layer to an appropriate range. Due to a synergistic effect of the polyvinylidene fluoride and the carbon nanotubes, dispersibility of the positive electrode active material, polyvinylidene fluoride, and carbon nanotubes in the positive electrode mixture Slurry is improved, and this enables uniform application of the slurry. In addition, the polyvinylidene fluoride and the carbon nanotubes act compositely to enhance the Strength of adhesion between the positive electrode active material particles and improve electron conductivity. Due to these synergistic effects, low resistance can be achieved in the positive electrode and the battery. Even when the amount of polyvinylidene fluoride is small, these advantages can be obtained by setting the number of molecules of the polyvinylidene fluoride contained per unit mass of the positive electrode mixture layer to a predetermined range.

An example embodiment of the present disclosure will now be described in detail. Although a secondary battery 100 having a rectangular metal outer casing 1 is illustrated as an example in the present embodiment, the shape of the outer casing is not limited to a rectangular shape, and may be, for example, a cylindrical shape or the like. Further, although a spiral-type electrode assembly 3 in which a positive electrode and a negative electrode are wound with separators located between the electrodes is illustrated as an example, the electrode assembly may be of a laminated type formed by alternately laminating a plurality of positive electrodes and a plurality of negative electrodes one by one via separators. The electrode assembly 3 is preferably of a spiral type. Further, although a case in which the mixture layer in each of the positive and negative electrodes is formed on both sides of the core is illustrated as an example, the present disclosure is not limited to a case in which each core has mixture layers formed on both sides, and it is sufficient so long as the core has a mixture layer formed on at least one surface.

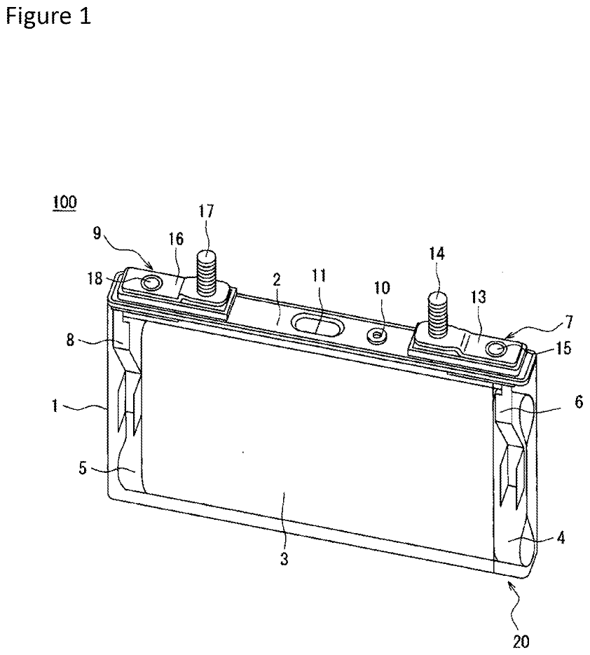

As illustrated for example in FIG. 1, the secondary battery 100 comprises: a spiral-type electrode assembly 3 in which a positive electrode and a negative electrode are wound with separators located between the electrodes and are formed into a flat shape having a flat part and a pair of curved parts; an electrolyte: and an outer casing 1 that houses the electrode assembly 3 and the electrolyte. Both of the outer casing 1 and a sealing plate 2 are made of metal, and are preferably made of aluminum or an aluminum alloy.

The outer casing 1 has a bottom portion having a substantially rectangular shape as viewed from the bottom face, and a side wall portion erected on the peripheral edge of the bottom portion. The Side wall portion is formed perpendicular to the bottom portion. The dimensions of the outer casing 1 are not particularly limited, but as an example, the outer casing 1 has a lateral length of 60 to 160 mm, a height of 60 to 100 mm, and a thickness of 10 to 40 mm.

The positive electrode is an elongate member which comprises a positive electrode core made of metal and positive electrode mixture layers formed on both sides of the core, and in which, at one end in the crosswise direction and along the lengthwise direction, the positive electrode core is exposed to form a strip-shaped positive electrode core exposed portion 4. Similarly, the negative electrode is an elongate member which comprises a negative electrode core made of metal and negative electrode mixture layers formed on both sides of the core, and in which, at one end in the crosswise direction and along the lengthwise direction, the negative electrode core is exposed to form a strip-shaped negative electrode core exposed portion 5. The electrode assembly 3 has a structure in which the positive electrode and the negative electrode are wound with separators located between the electrodes, with the positive electrode core exposed portion 4 of the positive electrode being arranged on one end side in the axial direction and the negative electrode core exposed portion 5 of the negative electrode being arranged on the other end side in the axial direction.

A positive electrode current collector 6 is connected to a laminated part of the positive electrode core exposed portion 4 of the positive electrode, and a negative electrode current collector 8 is connected to a laminated part of the negative electrode core exposed portion 5 of the negative electrode. A preferred positive electrode current collector 6 is made of aluminum or an aluminum alloy. A preferred negative electrode current collector 8 is made of copper or a copper alloy. A positive electrode terminal 7 comprises a positive electrode external conductive portion 13 arranged on the battery outer side of the sealing plate 2, a positive electrode bolt portion 14 connected to the positive electrode external conductive portion 13, and a positive electrode insertion portion 15 inserted into a through hole provided in the sealing plate 2, and the positive electrode terminal 17 is electrically connected to the positive electrode current collector 6. Further, a negative electrode terminal 9 comprises a negative electrode external conductive portion 16 arranged on the battery outer side of the sealing plate 2, a negative electrode bolt portion 17 connected to the negative electrode external conductive portion 16, and a negative electrode insertion portion 18 inserted into a through hole provided in the sealing plate 2, and the negative electrode terminal 9 is electrically connected to the negative electrode current collector 8.

The positive electrode terminal 7 and the positive electrode current collector 6 are fixed to the sealing plate 2 via an internal insulating member and an external insulating member, respectively. The internal insulating member is arranged between the sealing plate 2 and the positive electrode current collector 6, and the external insulating member is arranged between the sealing plate 2 and the positive electrode terminal 7. Similarly, the negative electrode terminal 9 and the negative electrode current collector 8 are fixed to the sealing plate 2 via an internal insulating member and an external insulating member, respectively. The internal insulating member is arranged between the sealing plate 2 and the negative electrode current collector 8, and the external insulating member is arranged between the sealing plate 2 and the negative electrode terminal 9.

The electrode assembly 3 is housed in the outer casing 1. The sealing plate 2 is connected to the opening edge part of the outer casing 1 by laser welding or the like. The sealing plate 2 has au electrolyte injection port 13, and this electrolyte injection port 10 is sealed with a sealing plug after the electrolyte is injected into the outer casing 1. The sealing plate 2 has formed therein a gas discharge valve 11 for discharging gas when pressure inside the battery reaches a predetermined value or higher.

Detailed descriptions will now be given regarding the positive electrode, the negative electrode, and the separator constituting the electrode assembly 3, and the non-aqueous electrolyte, and in particular regarding the positive electrode mixture layer constituting the positive electrode.

[Positive Electrode]

The positive electrode comprises a positive electrode core and a positive electrode mixture layer formed on a surface of the positive electrode core. For the positive electrode core, it is possible to use a foil of a metal stable in the potential range of the positive electrode such as aluminum or an aluminum alloy, a film having such a metal disposed on its surface layer, or the like.

The positive electrode mixture layer contains at least a positive electrode active material, carbon nanotubes (hereinafter may be referred to as CNN serving as a conductive auxiliary material, and polyvinylidene fluoride (hereinafter may be referred to its PVdF) serving as a binder. The positive electrode can be produced by applying a positive electrode mixture slurry containing the positive electrode active material, the conductive auxiliary material, the binder, and the like onto the positive electrode core, and after drying the applied coating, compressing the applied coating to form positive electrode mixture layers on both sides of the positive electrode core. The thickness of the positive electrode mixture layers is, for example, 10 μm to 150 μm on one side of the positive electrode core.

The porosity of the positive electrode mixture layer is 23% by volume to 50% by volume. The porosity of the positive electrode mixture layer is calculated according to the following formula, based on the bulk density of the positive electrode mixture layer and the true density and content of the respective components contained in the positive electrode mixture layer such as the positive electrode active material, the conductive auxiliary material, the binder, and the like. By adjusting the compressibility of the positive electrode mixture layer, the hulk density of the positive electrode mixture layer can be changed, so that the porosity of the positive electrode mixture layer can be changed.

Porosity of Positive Electrode Mixture Layer=1−(Sum of (Content/True Density) of Respective Components×Bulk Density of Positive Electrode Mixture Layer)

Examples of the positive electrode active material contained in the positive electrode mixture layer include lithium transition metal oxides containing transition metal elements such as Co, Mn, and Ni. Lithium transition metal oxides are, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, Li_{y}Mn₂O₄, LiₓMn_{2-y}M₃O₄, LiMPO₄, and Li₂MPO₄F (where M is at least one of Na, Mg, Sc, Y, Mn, Fe, Co, Ni, Cu, Zn, Al, Cr, Ph, Sb, and B, 0<x≤1.2, 0<y≤0.9, and 2.0≤z≤2.3). The foregoing may be used alone or by mixing a plurality thereof. In terms of enabling an increase in the capacity of the non-aqueous electrolyte secondary battery, the positive electrode active material preferably contains a lithium-nickel composite oxide such as LiₓNiO₂, LiₓNi_{1-y}O₂, LiₓNi_{1-y}M_{y}O_{z} (where M is at least one of Na, Mg, Sc, Y, MP. Fe, Co, Ni, Cu, hi, Al, Cr, Pb, Sb, and B, 0<x≤1.2, 0<y≤0.9, and 2.0≤z≤2.3), and the like.

The CNTs contained in the positive electrode mixture layer may be either single-walled carbon nanotubes (SWCNT) or multi-walled carbon nanotubes (MWCNT). As MWCNTs, for example, it is possible to use: CNTs having a tubular structure in which graphene sheets composed of six-membered carbon rings are wound parallel to the fiber axis; CNTs having a platelet structure in which graphene sheets composed of six-membered carbon rings are arranged perpendicular to the fiber axis; CNTs having a herringbone structure in which graphene sheets composed of six-membered carbon rings are wound at an oblique angle with respect to the fiber axis; and the like. In addition to the CNTs, the positive electrode mixture layer may also contain a carbon material such as carbon black, acetylene black (AB), Ketjen black, or graphite as a conductive auxiliary material.

The CNTs have a particle diameter of 5 nm to 40 nm and an aspect ratio of 100 to 1000. By satisfying these ranges, interaction with the PVdF occurs so that low resistance can be achieved in the positive electrode and the battery. Here, the particle diameter of the CNTs is determined by measuring the diameters of 10 CNTs using a scanning electron microscope (hereinafter may be referred to as SEM) and obtaining an average value thereof. Further, the length of the CNTs is determined by measuring the lengths of 10 CNTs using an SEM and obtaining an average value thereof. For example, the CNTs are observed using an SEM at an acceleration voltage of 5 kV, and in an image (having 1024×1280 pixels) with a magnification of 50.000 times, the diameters and lengths of 10 arbitrary CNTs are measured. From the average values thereof, the particle diameter and the length can be determined. The aspect ratio is a value obtained by dividing the length by the particle diameter.

The CNT content in the positive electrode mixture layer is 0.2% by mass to 5% by mass, and preferably 1.5% by mass to 3% by mass. When within this range, dispersibility of the CNTs in the positive electrode mixture slurry is improved, so that a positive electrode and a battery having lower resistance can be obtained.

The number of molecules of the PVdF contained per unit mass of the positive electrode mixture layer is 0.005 to 0.030, and preferably 0.007 to 0.011. By satisfying this range, interaction with the CNTs occurs so that low resistance can be achieved in the positive electrode and the battery. Here, the number of molecules of the PVdF contained per unit mass of the positive electrode mixture layer is a value obtained by dividing the PVdF content (by mass) in the positive electrode mixture layer by the molecular weight (g/mol) of the PVdF.

The polyvinylidene fluoride content in the positive electrode mixture layer may be 0.3% by mass to 2.5% by mass. With this feature, a positive electrode and a battery having lower resistance can be obtained.

The molecular weight of the polyvinylidene fluoride may be 1.1 million to 1.4 million. With this feature, a positive electrode and a battery having lower resistance can be obtained. Further, in addition to the PVdF, the positive electrode mixture layer may also contain, as a hinder, a fluororesin such as polytetrafluoroethylene (PTFE), polyacrylonitrile (PAN), polyimide, acrylic resin, polyolefin, or the like, and in combination with these resins, carboxymethyl cellulose (CMC) or a salt thereof, polyethylene oxide (PEO), or the like may be used.

[Negative Electrode]

The negative electrode comprises a negative electrode core and a negative electrode mixture layer formed on a surface of the negative electrode core. For the negative electrode core, it is possible to use a foil of a metal stable in the potential range of the negative electrode such as copper or a copper alloy, a film having such a metal disposed on its surface layer, or the like. The negative electrode mixture layer contains a negative electrode active material and a hinder. The thickness of the negative electrode mixture layer is, for example, 10 am to 150 μm on one side of the current collector. The negative electrode can be produced by applying a negative electrode mixture slurry containing the negative electrode active material, the binder, and the like onto the negative electrode core, and after drying the applied coating, compressing the applied coating to form negative electrode mixture layers on both sides of the negative electrode core.

The negative electrode active material is not particularly limited so long as it can reversibly occlude and release lithium ions, and a carbon material such as graphite is generally used therefor. The graphite may be either natural graphite such as scaly graphite, lump graphite, and earthy graphite, or artificial graphite such as lump artificial graphite and graphitized mesophase carbon microbeads. Further, as the negative electrode active material, it is possible to use a metal that forms an alloy with Li such as Si or Sn, a metal compound containing Si, Sn, or the like, a lithium titanium composite oxide, and so on. For example, in combination with graphite, a Si-containing compound represented by SiOₓ (Where 0.5≤x≤1.6), a Si-containing compound in which fine particles of Si are dispersed in a lithium silicate phase represented by Li_{2y}SiO_{(2+y)} (where 0<y<2), car the like may be used.

As the binder contained in the negative electrode mixture laver, a fluororesin such as PTFE or PVdF, PAN, polyimide, acrylic resin, polyolefin, or the like may be used as with the positive electrode, but styrene-butadiene rubber (SBR) is preferably used. The negative electrode mixture layer may further contain CMC or a salt thereof, polyacrylic acid (FAA) or a salt thereof, polyvinyl alcohol (PVA), and the like. The negative electrode mixture layer contains, for example, SBR and CMC or a salt thereof.

[Separator]

For the separator, a porous sheet having ion permeability and insulating property is used. Specific examples of the porous sheet include a microporous thin film, a woven fabric, and a non-woven fabric. As the material of the separator, olefins such as polyethylene and polypropylene, cellulose, and the like are preferred. The separator may have a single-layer structure or a laminated structure. On a surface of the separator, there may be provided a resin layer made of a resin having high heat resistance such as aramid resin, or a filler layer containing an inorganic compound filler.

[Non-Aqueous Electrolyte]

The non-aqueous electrolyte includes a non-aqueous solvent and an electrolyte salt dissolved, in the non-aqueous solvent. As the non-aqueous solvent, it is possible to use, for example, an ester, an ether, a nitrile such as acetonitrile, an amide such as dimethylformamide, a mixed solvent containing two or more of the foregoing, or the like. The non-aqueous solvent may contain a halogen-substituted product obtained by substituting at least part of the hydrogens in the above solvents with a halogen atom such as fluorine. Examples of the halogen-substituted product inch de fluorinated cyclic carbonates such as fluoroethylene carbonate (FEC); fluorinated chain carbonates; and fluorinated chain carboxylates such as fluoro methyl propionate (FMP).

Examples of the above-noted ester include: cyclic carbonates such as ethylene carbonate (EC), propylene carbonate (PC), and butylene carbonate; chain carbonates such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylates such as γ-butyrolactone (GBL) and γ-valerolactone (GATL); and chain carboxylates such as methyl acetate, ethyl acetate, propyl acetate, methyl propionate (MP), and ethyl propionate.

Examples of the above-noted ether include: cyclic ethers such as 1,3-dioxolane, 4-methyl-1,3-dioxolane, tetrahydrofuran, 2-methyltetrahydrofran, propylene oxide, 1,2-butylene oxide, 1,3-dioxane, 1,4-dioxane, 1,3,5-trioxane-2-methylfuran, 1,8-cineole, and crown ethers; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxybenzene-1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

The electrolyte salt is preferably lithium salt. Examples of lithium salt include LiBF₄, LiClO₄, LiPF₆, LiAsF₆, LiSbF₆, LiAlCl₄, LiSCN, LiCF₃SO₃, LiCE₃CO₂, Li(P(C₂O₄)F₄), LiPF₆₋ₓ(CₙF₂ₙ₊₁)ₓ (where 1<x<6, and n is 1 or 2), LiB₁₀Cl₁₀, LiCl, LiBr, LiI, chloroborane lithium, lower aliphatic lithium carboxylate, borates such as Li₂B₄O₇ and Li(B(C₂O₄)F₂), and imide salts such as LiN(SO₂CF₃)₂ and LiN(C₁F₂ₗ₊₁SO₂)(CₘF₂ₘ₊₁+SO₂) (where l and m each are an integer of 0 or greater). As the lithium salt, a single type among the above may be used alone, or a plurality of types may be mixed and used. Among the foregoing, it is preferable to use LiPF₆ in consideration of ion conductivity, electrochemical stability, and the like. The concentration of lithium salt may be, for example, 0.8 mol to 1.8 mol per 1 liter of the non-aqueous solvent.

### EXAMPLES

While the present disclosure is further described below by reference to Examples, the present disclosure is not limited to these Examples.

### Example 1

[Production of Positive Electrode]

As the positive electrode active material, a lithium transition metal composite oxide represented by LiNi_{1/3}Co_{1/3}Mn_{1/3}O₂ was used. As the CNTs that serve as the conductive auxiliary material, CNTs Laving a particle diameter of 10 nm and an aspect ratio of 100 to 1000 (hereinafter referred to as CNT-A) were used. As the PVdF, PVdF having a molecular weight of 1.1 million was used. The positive electrode active material, the CNTs, and the PVdF were mixed at a mass ratio of 97.3:0.2:2.5, and the mixture was kneaded while adding N-methyl-2-pyrrolidone (NMP) to thereby prepare a positive electrode mixture slurry. Next, the positive electrode Mixture slurry was applied to both sides of a positive electrode core made of an aluminum foil while leaving out portions to be connected with a lead, and the applied coating was dried. Then, after the applied coating was rolled using a roller so that the porosity of the positive electrode mixture layer was 50% by volume, the product was cut to a predetermined electrode size, and a positive electrode having positive electrode mixture layers formed on both sides of the positive electrode core was thereby produced.

[Production of Negative Electrode]

Graphite that serves as the negative electrode active material, a sodium salt of CMC, and a SBR dispersion were mixed at a solid content mass ratio of 99:0.6:0.4, and an appropriate amount of water was added to thereby prepare a negative electrode mixture slurry. Next, the negative electrode mixture slurry was applied to both sides of a negative electrode core made of a copper foil while leaving out portions to be connected with a lead, and the applied coating was dried. Then, after the applied coating was rolled using a roller, the product was cut to a predetermined electrode size, and a negative electrode having negative electrode mixture layers formed on both sides of the negative electrode core was thereby produced. The packing density of the negative electrode mixture layer was 1.17 g/cm³.

[Preparation of Non-Aqueous Electrolyte]

Into 100 parts by mass of a mixed solvent obtained by mixing ethylene carbonate (EC), dimethyl carbonate (DMC), and ethyl methyl carbonate (EMC) at a volume ratio of 25:35:40, vinylene carbonate (VC) was added in an amount of 1 part by mass, and LiPF₆ was dissolved therein at a ratio of 1.15 mol/L to thereby prepare a non-aqueous electrolyte.

[Production of Test Cell]

Leads were attached to the above-described negative electrode and the above-described positive electrode, respectively, and a laminated-type electrode assembly was produced in which the respective electrodes were alternately laminated one by one via separators. As the separator, a single-layer polypropylene separator was used. The produced electrode assembly and the above-described non-aqueous electrolyte were housed in a rectangular battery housing to thereby produce a test cell.

[Measurement of Mixture Layer Resistance and Interfacial Resistance]

For the positive electrode before being incorporated into the test cell, the mixture layer resistance (Ω·cm), which is the resistance of the entire mixture layer, and the interfacial resistance (Ω·cm²), which is the resistance between the positive electrode core and the positive electrode mixture layer, were measured. An amount of increase in mixture layer resistance and an amount of increase in interfacial resistance were each calculated by subtracting a measurement result obtained for the positive electrode produced as described above from a measurement result obtained for the positive electrode that has been immersed in dimethyl carbonate (DMC) at 80° C. for 18 hours and then taken out. For measuring the mixture layer resistance and the interfacial resistance, an electrode resistance measuring instrument (device name: XF057) manufactured by Hioki E.E. Corporation was used.

[Evaluation of Direct Current Resistance]

With respect to the above-described test cell, constant current charging was performed with a constant current of 0.3 C a 25° C. environment until the depth of charge (SOC) reached 50% and after reaching 50 SOC, constant voltage charging was performed until the current value reached 0.02 C. Subsequently, constant current discharge was performed with a constant current of 50 C for 10 seconds. The direct current resistance was calculated by dividing the difference between the open circuit voltage (OCV) and the closed circuit voltage (CCV) 10 seconds after the discharge by the discharge current 10 seconds after the discharge, as shown in the following formula.

Direct Current Resistance=[OCV−CCV(10 seconds after discharge)]/Discharge Current(10 seconds after discharge)

### Examples 2 to 14 and Comparative Examples 1 to 21

Positive electrodes and test cells were produced and evaluated in the same manner as in Example 1 except that the positive electrode active material content, the type and content of the conductive auxiliary material, the content and molecular weight of the PVdF, and the porosity of the positive electrode mixture layer were changed as shown in Tables 1 and 2. Here, the conductive auxiliary material CNT-B is CNTS having a particle diameter of 150 nm and an aspect ratio of 10 to 70.

Tables 1 and 2 summarize the results of the amount of increase in mixture layer resistance, the amount of increase in interfacial resistance, and the direct current resistance for the Examples and Comparative Examples. Tables 1 and 2 also show the composition of the positive electrode mixture layer composed of the positive electrode active material, the conductive auxiliary material, and PVdF, and the porosity of the positive electrode mixture layer.

TABLE 1

| | Composition of Positive Electrode Mixture Layer | | | | | | | | | | |
|---|---|---|---|---|---|---|---|---|---|---|---|
| | | | | | Binder (PVdF) | | | | | | |
| | | | | | | | PVdF | | Evaluation Results | | |
| | | | | | | | Content/ | Porosity of | Amount of | | |
| | Positive | | | | | PVdF | Molecular | Positive | Increase | Amount of | |
| | Electrode | | | | | Molecular | Weight | Electrode | in Mixture | Increase in | Direct |
| | Active | Conductive Auxiliary Material | | | | Weight | [wt %/ | Mixture | Layer | Interfacial | Current |
| | Material | CNT-A | CNT-B | AB | PVdF | [×10\hat{ }4 g/ | (10\hat{ }4 g/ | Layer | Resistance | Resistance | Resistance |
| | [wt %] | [wt %] | [wt %] | [wt %] | [wt %] | mol] | mol)] | [vol %] | [Ω · cm] | [Ω · cm²] | [mΩ] |
| Example 1 | 97.3 | 0.2 | 0.0 | 0.0 | 2.5 | 110 | 0.023 | 50 | 0.802 | 0.083 | 58.1 |
| Example 2 | 97.8 | 0.2 | 0.0 | 0.0 | 2.0 | 140 | 0.014 | 44 | 0.669 | 0.068 | 56.7 |
| Example 3 | 98.3 | 0.2 | 0.0 | 0.0 | 1.5 | 140 | 0.011 | 38 | 0.598 | 0.051 | 55.4 |
| Example 4 | 99.0 | 0.2 | 0.0 | 0.0 | 0.8 | 140 | 0.006 | 34 | 0.581 | 0.051 | 55.4 |
| Example 5 | 96.0 | 1.5 | 0.0 | 0.0 | 2.5 | 110 | 0.023 | 49 | 0.689 | 0.057 | 56.1 |
| Example 6 | 96.5 | 1.5 | 0.0 | 0.0 | 2.0 | 140 | 0.014 | 43 | 0.589 | 0.023 | 53.9 |
| Example 7 | 97.0 | 1.5 | 0.0 | 0.0 | 1.5 | 140 | 0.011 | 37 | 0.406 | 0.012 | 54.8 |
| Example 8 | 97.7 | 1.5 | 0.0 | 0.0 | 0.8 | 140 | 0.006 | 33 | 0.399 | 0.013 | 54.5 |
| Example 9 | 98.2 | 1.5 | 0.0 | 0.0 | 0.3 | 140 | 0.002 | 33 | 1.324 | 0.153 | 62.7 |
| Example 10 | 96.2 | 1.5 | 0.0 | 1.5 | 0.8 | 140 | 0.006 | 31 | 0.395 | 0.012 | 54.0 |
| Example 11 | 92.5 | 5.0 | 0.0 | 0.0 | 2.5 | 110 | 0.023 | 47 | 0.678 | 0.053 | 56.9 |
| Example 12 | 93.0 | 5.0 | 0.0 | 0.0 | 2.0 | 140 | 0.014 | 41 | 0.580 | 0.020 | 57.9 |
| Example 13 | 93.5 | 5.0 | 0.0 | 0.0 | 1.5 | 140 | 0.011 | 32 | 0.392 | 0.012 | 54.2 |
| Example 14 | 94.2 | 5.0 | 0.0 | 0.0 | 0.8 | 140 | 0.006 | 23 | 0.388 | 0.011 | 54.3 |

TABLE 2

| | | | | | | | | | | | |
|---|---|---|---|---|---|---|---|---|---|---|---|
| Comparative | 97.1 | 0.0 | 0.2 | 0.0 | 2.7 | 90 | 0.030 | 50 | 2.711 | 0.496 | 76.5 |
| Example 1 | | | | | | | | | | | |
| Comparative | 97.8 | 0.0 | 0.2 | 0.0 | 2.0 | 140 | 0.014 | 44 | 2.003 | 0.382 | 70.4 |
| Example 2 | | | | | | | | | | | |
| Comparative | 99.0 | 0.0 | 0.2 | 0.0 | 0.8 | 140 | 0.006 | 38 | 2.454 | 0.516 | 74.9 |
| Example 3 | | | | | | | | | | | |
| Comparative | 95.8 | 0.0 | 1.5 | 0.0 | 2.7 | 90 | 0.030 | 49 | 2.643 | 0.453 | 76.1 |
| Example 4 | | | | | | | | | | | |
| Comparative | 96.5 | 0.0 | 1.5 | 0.0 | 2.0 | 140 | 0.014 | 43 | 1.769 | 0.337 | 67.7 |
| Example 5 | | | | | | | | | | | |
| Comparative | 97.7 | 0.0 | 1.5 | 0.0 | 0.8 | 140 | 0.006 | 37 | 2.114 | 0.391 | 71.2 |
| Example 6 | | | | | | | | | | | |
| Comparative | 92.3 | 0.0 | 5.0 | 0.0 | 2.7 | 90 | 0.030 | 47 | 2.630 | 0.441 | 76.4 |
| Example 7 | | | | | | | | | | | |
| Comparative | 93.0 | 0.0 | 5.0 | 0.0 | 2.0 | 140 | 0.014 | 41 | 1.711 | 0.329 | 67.4 |
| Example 8 | | | | | | | | | | | |
| Comparative | 94.2 | 0.0 | 5.0 | 0.0 | 0.8 | 140 | 0.006 | 35 | 2.109 | 0.385 | 71.8 |
| Example 9 | | | | | | | | | | | |
| Comparative | 95.8 | 0.0 | 0.0 | 1.5 | 2.7 | 90 | 0.030 | 49 | 2.407 | 0.589 | 72.3 |
| Example 10 | | | | | | | | | | | |
| Comparative | 96.5 | 0.0 | 0.0 | 1.5 | 2.0 | 110 | 0.018 | 43 | 2.339 | 0.491 | 71.8 |
| Example 11 | | | | | | | | | | | |
| Comparative | 97.0 | 0.0 | 0.0 | 1.5 | 1.5 | 140 | 0.011 | 36 | 2.203 | 0.399 | 71.1 |
| Example 12 | | | | | | | | | | | |
| Comparative | 97.7 | 0.0 | 0.0 | 1.5 | 0.8 | 140 | 0.006 | 32 | 2.978 | 0.54 | 73.0 |
| Example 13 | | | | | | | | | | | |
| Comparative | 92.3 | 0.0 | 0.0 | 5.0 | 2.7 | 90 | 0.030 | 46 | 1.922 | 0.488 | 68.0 |
| Example 14 | | | | | | | | | | | |
| Comparative | 93.0 | 0.0 | 0.0 | 5.0 | 2.0 | 110 | 0.018 | 40 | 1.765 | 0.433 | 66.7 |
| Example 15 | | | | | | | | | | | |
| Comparative | 93.5 | 0.0 | 0.0 | 5.0 | 1.5 | 140 | 0.011 | 33 | 1.677 | 0.324 | 65.8 |
| Example 16 | | | | | | | | | | | |
| Comparative | 94.2 | 0.0 | 0.0 | 5.0 | 0.8 | 140 | 0.006 | 23 | 2.534 | 0.478 | 75.5 |
| Example 17 | | | | | | | | | | | |
| Comparative | 94.2 | 0.0 | 0.0 | 5.0 | 0.8 | 140 | 0.006 | 29 | 2.109 | 0.468 | 70.7 |
| Example 18 | | | | | | | | | | | |
| Comparative | 90.3 | 0.0 | 0.0 | 7.0 | 2.7 | 90 | 0.030 | 45 | 1.848 | 0.461 | 67.4 |
| Example 19 | | | | | | | | | | | |
| Comparative | 91.0 | 0.0 | 0.0 | 7.0 | 2.0 | 110 | 0.018 | 38 | 1.743 | 0.428 | 66.3 |
| Example 20 | | | | | | | | | | | |
| Comparative | 91.5 | 0.0 | 0.0 | 7.0 | 1.5 | 140 | 0.011 | 31 | 1.602 | 0.318 | 65.8 |
| Example 21 | | | | | | | | | | | |

As can be seen from Tables 1 and 2, the resistance values of the positive electrode and the battery were smaller in all of Examples 1 to 14 as compared with Comparative Examples 1 to 21. Further, in Examples 1 to 14, the positive electrode active material content in the positive electrode mixture layer was 90% by amass or higher, and high-capacity positive electrode and battery could be produced.

### REFERENCE SIGNS LIST

1 outer casing
2 sealing plate
3 electrode assembly
4 positive electrode core exposed portion
5 negative electrode core exposed portion
6 positive electrode current collector
7 positive electrode terminal
8 negative electrode current collector
9 negative electrode terminal
10 electrolyte injection port
11 gas discharge valve
13 positive electrode external conductive portion
14 positive electrode bolt portion
15 positive electrode insertion portion
16 negative electrode external conductive portion
17 negative electrode bolt portion
18 negative electrode insertion portion
100 secondary battery

1. A positive electrode for non-aqueous electrolyte secondary battery, comprising
a positive electrode core and a positive electrode mixture layer formed on a surface of the positive electrode core, wherein
a porosity of the positive electrode mixture layer is 23% by volume to 50% by volume;
the positive electrode mixture layer contains at least a positive electrode active material, carbon nanotubes serving as a conductive auxiliary material, and polyvinylidene fluoride serving as a binder;
the carbon nanotubes have a particle diameter of 5 nm to 40 nm and an aspect ratio of 100 to 1000, and a content of the carbon nanotubes in the positive electrode mixture layer is 0.2% by mass to 5% by mass;
a number of molecules of the polyvinylidene fluoride contained per unit mass of the positive electrode mixture layer is 0.005 to 0.030.

2. The positive electrode for non-aqueous electrolyte secondary battery according to claim 1, wherein a content of the polyvinylidene fluoride in the positive electrode mixture layer is 0.3% by mass to 2.5% by mass.

3. The positive electrode for non-aqueous electrolyte secondary battery according to claim 1, wherein a molecular weight of the polyvinylidene fluoride is 1.1 million to 1.4 million.

4. A non-aqueous electrolyte secondary batter comprising the positive electrode for non-aqueous electrolyte secondary battery according to claim 1, a negative electrode, and a non-aqueous electrolyte.
